(19) United States
(12) Patent Application Publication
(10) Pub. No.: US 2016/0203500 A1
(43) Pub. Date: Jul. 14, 2016

(54) System for Improved Remote Processing and Interaction with Artificial Survey Administrator

(71) Applicant: InMoment, Inc., Salt Lake City, UT (US)

(72) Inventors: Kurtis Williams, Fruit Heights, UT (US); John Crofts, Sandy, UT (US)

(21) Appl. No.: 14/922,013

(22) Filed: Oct. 23, 2015

Related U.S. Application Data
(63) Continuation-in-part of application No. 14/203,384, filed on Mar. 10, 2014.
(60) Provisional application No. 61/775,370, filed on Mar. 8, 2013.

(51) Int. Cl. G06Q 30/02

(52) U.S. Cl. CPC G06Q 30/0203

(57) ABSTRACT

A system for improved remote processing and interaction with an artificial survey administrator is disclosed. The system has user-defined data storage containing lists of entities and attributes and correlation data with terms that correspond to the entities and attributes. An open-ended question generation module is present that provides an open-ended question over a network to a consumer of the specific good or service located remotely from the processor, the open-ended question being directed to the consumer's experience with said good or service A consumer response module is present that (i) analyzes the text of a response received from the consumer to the open-ended question, (ii) parses the text of the response into component parts, (iii) accesses the user-defined data storage containing a user-defined list of entities to determine if any component parts of the text of the response correspond to any of the list of entities, (iv) accesses the user-defined data storage containing a user-defined list of attributes to determine if any component parts of the text of the response correspond to any of the list of attributes, and (v) prompts the respondent to provide information regarding any missing entity or attribute to complete the pair.

### PRIORITY

This application claims priority to and is a continuation-in-part of U.S. patent application Ser. No. 14/203,384 filed on Mar. 10, 2014 entitled “Method and System for Deductive Surveying Based on Text Input” which is incorporated herein in its entirety by reference and U.S. Provisional Patent Application No. 61/775,370 filed on Mar. 8, 2013 entitled “Method and System for Deductive Surveying Based on Text Input” which is also incorporated herein by reference in its entirety.

### FIELD OF THE TECHNOLOGY

The present technology relates generally to computer systems for optimizing consumer surveys. More particularly, the present technology relates to an analysis tool that assesses customer responses to an open-ended survey question and tailors additional questions based on deductive processing tools.

### BACKGROUND

The present technology relates generally to solving computer network problems associated with the administration of consumer surveys by an artificial administrator by optimization of consumer analysis of text input, also known as customer comments, in consumer surveys to optimize survey length and the quality of consumer comments. Modern computer administered customer feedback surveys are difficult to correctly design, long and unpleasant for respondents to complete, difficult to analyze, suffer from data anomalies such as multi-co-linearity and a “halo effect,” can only ask a limited set of questions, and are “top down” focused on researcher requirements rather than customer experiences. In some instances, text analysis of consumer textual comments has been used generally to extrapolate information related to those responses, however the text analysis lacks proper disambiguation of critical terms that result in meaningful data useful to the provider of goods and services to the consumer so that the provider can identify “action items” to improve the consumer experience. Thus, a need exists for improved network and computer systems for artificial consumer survey administration, design, construction, operation, and use.

### SUMMARY

In light of the problems and deficiencies inherent in the prior art, the present technology seeks to overcome these by providing methods, devices, and systems for improved remote processing and interaction with an artificial survey administrator. In accordance with one aspect of the technology, the system has user-defined data storage containing lists of entities and attributes and correlation data with terms that correspond to the entities and attributes. An open-ended question generation module is present that provides an open-ended question over a network to a consumer of the specific good or service located remotely from the processor, the open-ended question being directed to the consumer's experience with said good or service A consumer response module is present that (i) analyzes the text of a response received from the consumer to the open-ended question, (ii) parses the text of the response into component parts, (iii) accesses the user-defined data storage containing a user-defined list of entities to determine if any component parts of the text of the response correspond to any of the list of entities, (iv) accesses the user-defined data storage containing a user-defined list of attributes to determine if any component parts of the text of the response correspond to any of the list of attributes, and (v) prompts the respondent to provide information regarding any missing entity or attribute to complete the pair.

### BRIEF DESCRIPTION OF THE DRAWINGS

Additional features and advantages of the technology will be apparent from the detailed description which follows, taken in conjunction with the accompanying drawings, which illustrate, by way of example, features of the technology; and, wherein:

FIG. 1 is a block diagram of components of a method according to one aspect of the technology;

FIG. 2 is a diagram of a static survey design;

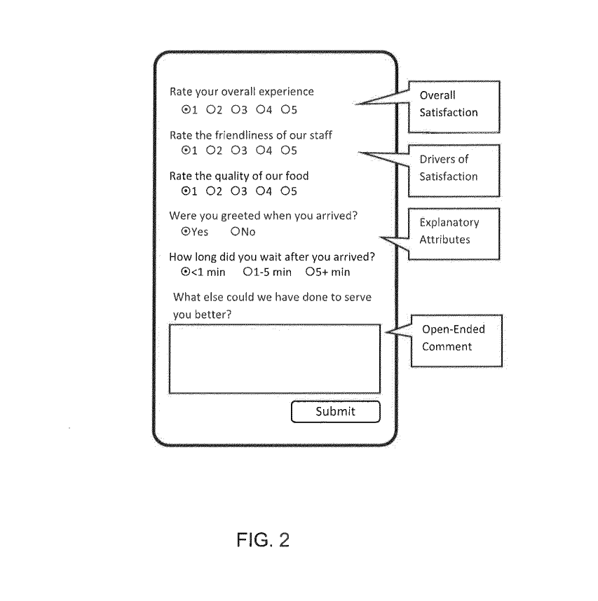

FIG. 3 is a diagram of a method according to one aspect of the technology;

FIG. 4 is a diagram of a method according to one aspect of the technology;

FIG. 5 is a diagram of a method according to one aspect of the technology;

FIG. 6 is a diagram of a method according to one aspect of the technology; and

FIG. 7 is a series of graphic-user interfaces and comments in accordance with one aspect of the technology.

### DESCRIPTION

Reference will now be made to, among other things, the exemplary aspects illustrated in the drawing, and specific language will be used herein to describe the same. It will nevertheless be understood that no limitation of the scope of the technology is thereby intended. Alterations and further modifications of the inventive features illustrated herein, and additional applications of the principles of the technology as illustrated herein, which would occur to one skilled in the relevant art and having possession of this disclosure, are to be considered within the scope of the technology.

Generally speaking, in accordance with one aspect of the technology, a system and method for conducting a deductive survey based on text input from a customer begins with asking the customer to answer at least one open-ended question about their overall experience with respect to a particular good or service. In real-time, the system analyzes the comment with voice and/or text analytics to determine what topics the customer discussed about their experience. Each topic mentioned by the customer is tagged and analyzed for sentiment. The next question, hint, prompt, or suggestion or set of questions, hints, prompts, or suggestions, would then be determined based on the customer response to the first and each successive question and so on. This approach is completely inverted from the typical approach to customer feedback surveys.

One purpose of consumer surveys is to gather data on attitudes, impressions, opinions, satisfaction level, etc. by polling a section of consumers in order to gauge consumer satisfaction. In accordance with one aspect of the technology, a survey takes the form of a questionnaire composed of questions that collect data. This data helps impose structure on the survey. The types of data collected can include (i) nominal data where the respondent selects one or more unordered options (e.g., “Which of the following did you like best about the product: Price, Taste, or Packaging?), (ii) ordinal data where the respondent chooses an ordered option (e.g., “Please rate the taste of the product from 1 to 5.”), (iii) dichotomous data where the respondent chooses one of two (possibly ordered) options (“Did you like the taste of the product?), and (iv) continuous data which is ordered on a (possibly bounded) continuous scale. These types of data are called structured data and are the result of a structured or closed-ended question. Unstructured textual data may be captured from structured responses including names, dates, addresses, and comments.

Data used to ascertain customer satisfaction can be obtained from multiple disparate data sources, including in-store consumer surveys, post-sale online surveys, voice surveys, comment cards, social media, imported CRM data, and broader open market consumer polling, for example. Several factors are included in determining a composite score or numerical representation of customer satisfaction. That numeral representation is referred to as a Customer Satisfaction Index (“CSI”) or Primary Performance Indicator (“PPI”). There are a number of other methods for deriving a composite numerical representation of customer satisfaction. For example, Net Promotor Score (NPS), Guest Loyalty Index (GSI), Overall Satisfaction (OSAT), Top Box, etc. are composite representations of the same. This list is not exhaustive and many other methods exist that use mathematical methods to derive a numeric representation of satisfaction or loyalty would be apparent for use herein by one of ordinary skill in the art. Efforts have been made to determine optimal actions to increase the PPI for a particular situation. Data retrieved from customer feedback sources ranking their satisfaction with a particular service or product is compiled and used to calculate an aggregate score. As such, the efficient procurement of correct consumer satisfaction data is critical.

The activities that will most likely have the greatest influence on the CSI, referred to as key drivers herein, are important to understand. Key driver analysis includes correlation, importance/performance mapping, and regression techniques. These techniques use historical data to mathematically demonstrate a link between the PPI (the dependent variable) and the key drivers (independent variables). Key drivers may both increase and decrease the PPI, or both, depending on the particular driver. For example, if a bathroom is not clean, customers may give significantly lower PPI ratings. However, the same customers may not provide significantly higher PPI ratings once the bathroom reaches a threshold level of cleanliness. That is, certain key drivers provide a diminishing rate of return. Other drivers may also be evaluated but that do not have a significant impact on PPI. For example, a restaurant may require the use of uniforms in order to convey a desired brand image. Although brand image may be very important to the business, it may not drive customer satisfaction and may be difficult to analyze statistically.

Once a PPI is determined and key drivers are identified, the importance of each key driver with respect to incremental improvements on the PPI is determined. That is, if drivers were rated from 1 to 5, moving an individual driver (e.g., quality) from a 2 to a 3 may be more important to the overall PPI than moving an individual driver (e.g., speed) from a 1 to a 2. When potential incremental improvement is estimated, key driver ratings for surveys are evaluated to determine the net change in the PPI based on incremental changes (either positive or negative) to key drivers. Specific actions necessary to incrementally modify the key drivers are determined after an optimum key driver scheme is determined. Those actions, referred to as specific or standard operating procedures (“SOPs”), describe a particular remedial step connected with improving each driver, optimizing profit while maintaining a current PPI, or incrementally adjusting PPI to achieve a desired profit margin. In short, the SOPs constitute a set of user specified recommendations that will ultimately be provided to improve the PPI score.

As noted above, one purpose of a survey is to study the behavior of a group of people and in particular to understand consumer preferences and consumer satisfaction with the goods and services of business and industry. As such, a model is useful to attempt to numerically describe the group of people in a predictable manner. In accordance with one aspect of the technology, a survey data model includes questions designed to understand a primary measured value (e.g., the PPI referenced above). The data acquired from a response to this question is also called the “dependent variable”, “regressand,” “measured variable,” “response”, “output variable,” or “outcome.” An example question seeking a primary measured value would include “Rate your overall experience on a scale of 1 to 5.” The model further includes one or more explanatory questions that explain the primary score. The data acquired from these types of questions are called “independent variables,” “key driver,” “regressor”, “controlled variable,” “explanatory variable”, or “input variable.” Similar to the question seeking information related to the primary measured value, a question seeking information related to the independent variable would include “Rate the service you received on a scale of 1 to 5.” Both of these questions are examples of closed-ended questions. While the response to each of these questions is specific and provides value information to the business concern, consumer surveys can be overly burdensome on consumers who do not wish to spend a lot of time to answer questions and who may not provide meaningful answers, if any, if the survey is too long. In order to acquire all of the information desired by the business concern, consumers may be requested to answer pages and pages of questions.

In addition, many survey designs suffer from a well-known cognitive bias called the “Halo Effect.” If a person has a positive or negative bias towards a particular brand (created by previous experiences or marketing, for example), then all answers from that person tend to be positively or negatively influenced. Comment narratives from the same consumers may be less subject to ratings' bias caused by the Halo Effect. Other flaws in survey design also contribute to bias. For example, long surveys tend to influence customers to “speed through” the survey and inaccurately answer the questions just to complete the survey. Or, questions may be designed such that consumers do not understand the question posed or cannot differentiate between the meanings of different, similarly posed, questions. For example, satisfaction surveys often ask respondents to “rate the friendliness of our staff” and then “rate the attentiveness of our staff” Both questions are seeking different information but may appear to be the same to many respondents. This is known as co-linearity and is a flaw that does not exist in textual analysis of consumer responses to open-ended questions.

As an example, a typical/traditional retail static consumer survey may ask the following questions:

1. Computer: “Please rate your overall satisfaction with the [service] on a scale from 1 to 5.” (The overall satisfaction may be an ordinal data point used as a primary performance indicator as noted above.)
2. Computer: “Please rate the service on a scale from 1 to 5.” (The service rating may be an ordinal data point used as a key driver.)
3. Computer: “Please rate the product on a scale from 1 to 5.” (The product rating may be an ordinal data point used as a key driver.)
4. Computer: “Please rate the selection of products on a scale from 1 to 5.” (The selection rating may be used as an ordinal data point in a key driver analysis as noted above.)
5. Computer: “Please rate the store appearance on a scale from 1 to 5.” (Again, this rating may be used as an ordinal data point in a key driver analysis.)
6. Computer: “What area of service could be improved?” (A response to this question would provide an explanatory attribute from a list of options and provides nominal data for use in survey analysis.)
7. Computer: “How could the product be improved?” (A response to this question would also be an explanatory attribute from a list of options and provides nominal data for use in survey analysis.)
8. Computer: “Were you greeted at the entrance of the store?” (A response to this question is also an explanatory attribute. However, the data procured is dichotomous or “a yes or no/true or false” response to be used in survey analysis.)
9. Computer: “Tell us about your experience.” (A response to this question/prompt would also provide an explanatory attribute but is unstructured text. The consumer is not provided any guidance as to what part of the service he or she liked or disliked and elaborates in an open-ended manner to provide insight into their perception.)

As noted above, surveys can become long as the set of explanatory features grows. Often some combinations of questions are nonsensical. For example, it is pointless to ask a question about a fast food restaurant's tables if the customer purchased via a drive-through window. However, because a particular business concern does not differentiate between those consumers when requesting a survey, it is required to pose the question nevertheless to capture information from a consumer that may have eaten at the restaurant. Moreover, a broad generic consumer survey may not even address the topics that are of primary concern to the consumer or drive the overall consumer satisfaction. For example, a business concern may ask about overall satisfaction and ask closed-ended questions the business concern believes affects overall satisfaction, but the consumer's concerns regarding the experience and overall satisfaction may not be included within the set of closed-ended questions. For example, a consumer may be dissatisfied with his or her overall experience at a drive-through window because it was raining and the drive-through was not covered. Unless the business concern includes this question in its survey, understanding the value of follow up questions to ascertain key drivers to improve overall customer satisfaction is diminished. That is, the consumer may rate food quality as high and service as high, but overall satisfaction low leaving the business concern with no valuable data on how to improve customer satisfaction. A business concern with numerous facilities (some with covered drive-through windows and some without) is therefore forced to include yet another question on a long list of possible consumer concerns.

In accordance with one aspect of the technology, it is desirable to ask follow-up questions that further explain a particular answer or, as noted further below, ask initial open-ended questions that drive the organization of the remainder of the survey. For example, if a customer initially rates product quality as low, it is useful to ask the customer what they did not like about quality. In accordance with one aspect of the technology, the model includes one or more descriptive questions that further explain a previous question and that can be used as secondary predictors of the primary value. These questions are also called “drill-in,” “attributes,” or “features.” For example, if the consumer gave a low score to service, a closed-ended follow-up question might be “Select what was bad about the service you received: (“slow|rude|incorrect”).” The data model is used for data analysis including trending, comparative studies and statistical/predictive modeling. This data is structured and can be modeled inside a computer database. Even though surveys can be very detailed with many questions, they often cannot capture every case. Here, the consumer score regarding service may not be poor because of the three items provided in the closed-ended question. Advantageously, an unstructured text or “open-ended question” may be used for the respondent to use to fill in the gaps or for a user to gauge what is most important to the consumer's experience with his or her goods. For example, an open-ended question following a low score on service might be “Tell us in your own words why you rated us poorly on our service.” In this manner, the business concern is not limited by the specific set of potential problems the consumer may have encountered. As a result, survey length may be shortened and the value of information harvested from consumer responses is improved.

In one aspect of the technology, a customer might be asked the following open-ended question at the beginning of a consumer survey: “Please tell us about your experience.” If a customer left the following feedback “I had a good experience at your restaurant and was very pleased with how friendly and attentive Sam was with our party. Our food did take a little bit longer than usual to come out, but our party was pretty large. Thanks for a fun and enjoyable time,” the following facts would be extracted from text analysis of the consumer response.

1. The customer was overall satisfied with the experience
2. The friendliness and attentiveness of the staff was great
3. The speed of service was good

These facts are used to deductively generate additional questions that are contextually relevant to the consumer experience. This allows a direct survey where the respondents are required to endure less questions. The effectiveness of the questions and value of the data retrieved from the questions is more reliable as they relate specifically to the feedback generated by the consumer.

In accordance with one aspect of the technology, automated linguistics-based analyses of data are used to assess grammatical structures and meaning within the consumer responses. These solutions are based on natural language processing (NLP) or computational linguistics and are useful in identifying topics of interest contained in consumer responses to open-ended questions. For example, linguistics-based classification techniques are used to group noun terms. The classification creates categories by identifying terms that are likely to have the same meaning (also called synonyms) or are either more specific than the category represented by a term (also called hyponyms) or more general (hyperonyms). For additional accuracy, the linguistic techniques excludes adjective terms and other qualifiers. In another aspect of the technology, categories are created by grouping multiple-word terms whose components have related word endings (also called suffixes). This technique is very useful for identifying synonymous multiple-word terms, since the terms in each category generated are synonyms or closely related in meaning. In another aspect, categories are created by taking terms and finding other terms that include them. This approach based on term inclusion often corresponds to a taxonomic hierarchy (a semantic “is a” relationship). For example, the term sports car would be included in the term car. One-word or multiple-word terms that are included in other multiple-word terms are examined first and then grouped into appropriate categories. In another aspect of the technology, categories are created based on an extensive index of word relationships. First, extracted terms that are synonyms, hyponyms, or hyperonyms are identified and grouped. A semantic network (or classification module) with algorithms is used to filter out nonsensical results. This technique produces positive results when the terms are known to the semantic network and are not too ambiguous. It is less helpful when text contains a large amount of specialized, domain-specific terminology that the network does not recognize.

In accordance with one aspect of the technology, a statistical analysis of text is based on the frequency with which terms, types, or patterns occur. This technique can be used both on noun terms and or other qualifiers. Frequency refers to the number of records containing a term or type and all its declared synonyms. Grouping items based on how frequently they occur may indicate a common or significant response. This approach produces positive results when the text data contains straightforward lists or simple terms. It can also be useful to apply this technique to any terms that are still uncategorized after other techniques have been applied.

In accordance with one aspect of the technology, the taxonomies, ontologies, dictionaries, and business rules used to extract information from unstructured text may be further customized and enhanced for a specific industry or organization. Domain knowledge experts who are well versed in a particular industry or organization is encoded into the text analytics systems. In this manner, the system provides more contextually relevant questions to the survey respondent rather than “off the shelf” text analytics that lack contextual reasoning and logic. For example, restaurant terminology is different from retail clothing terminology as is insurance and contact center terminologies. Business rules for each specific industry is integrated with an industry specific survey.

The facts extracted from customer comments through NLP technology are used to restructure a survey in real time. That is, the facts are used to dynamically create follow-up questions while the survey is being conducted. One example of an open-ended question and follow-up questions is presented below. In this example, a hotel manager desires to understand how customers rate their experience and what was most important to them. Rather than provide a long list of questions that may or may not be of concern to the consumer, an open-ended question is posed to provide the consumer with the opportunity to identify those areas that were most important to the consumer. Follow-up questions are generated in response to the facts and topics of interest generated by the consumer as well as topics of interest generated by the user of the model. In this example, information that the hotel manager identifies as important to the business includes: overall experience rating, service rating, room rating, fair price, and concierge service rating. All other data is optional but still useful to the hotel manager. The system first poses an open-ended question as noted below with an example response from the consumer.

Computer: “Tell us in your own words about your experience.”
Consumer: “I really didn't have a good experience with your hotel. The bell service was slow and a bit rude, plus I didn't get room service at all. At the prices you charge, I expect more.”

Based on the consumer response, the following facts might be extracted from the comment using NLP or computational linguistics: The consumer had a poor experience; the bell service was slow; the employees were rude; room service was poor; price was mentioned; and expectations were not met. Based on the facts extracted from the comment, the system generates a set of closed-ended follow-up questions in order to obtain ratings with respect to the specific items referenced. Additionally, specific questions that the system user (i.e., the hotel manager) wishes to be asked as part of the survey are included to rate user-generated topics in addition to the consumer-generated topics of interest. The following is one example set of follow-up questions:
1. Computer: “I'm sorry you had a poor experience. We'd like to do better. Can you rate your experience on a scale of 1 to 5?”

### Consumer: 5

2. Computer: “You mentioned price, was the price you were charged fair?”

### Consumer: No

3. Computer: “You didn't mention the concierge service. Did you use it?”

### Consumer: Yes

4. Computer: “Please rate the concierge service on a scale of 1 to 5.”

### Consumer: 4

5. Computer: “Can you tell us what you liked about the concierge?”
   Consumer: “They helped us find tickets to a sold out show. That was very helpful.”
6. Computer: “One last question, can you rate the quality of your room?”

### Consumer: 4

In the example noted above, question number 1 is a closed-ended follow-up question that is based on a consumer-generated topic of interest and provides the user of the system, again the hotel manager in this example, valuable feedback that has a direct correlation to the consumer's comment. Question number 2 also asks a closed-ended follow-up question correlated to a consumer-generated topic of interest with a specific rating. Questions 3 through 6 are follow-up questions that are user-generated. That is, the user of the system may have specific business goals and/or other operational concerns for which it desires direct consumer feedback. As such, in addition to closed-ended questions correlated to consumer-generated topics of interest, open and closed-ended questions are asked based on user-generated topics of interest. In one aspect of the technology, those follow-up questions are only generated if the topics are not already identified in the consumer-generated topics of interest. However, in one aspect of the technology, the user-identified topics may not be asked at all depending on the length of the consumer response, the number of consumer-identified topics that are generated from the textual analysis, and the relative value of the information to the user. This allows the survey to be dramatically shorter. For example, if parking lot cleanliness is less important than the friendliness of the staff and the open-ended structure herein had already elicited greater than a user-defined threshold number of follow-up questions, specific questions related to parking lot cleanliness may not be asked. In this manner, the user sets a “respondent tolerance level” for answering and responding to questions which is balanced with the relative value of information sought through the survey.

In accordance with one aspect of the technology, an analysis (e.g., employing statistics, specific business rules, or otherwise) of the topics identified in consumer responses is performed to assess the confidence in the results of identified topics. Closed-ended follow-up questions are asked regarding topics that were identified by the user as important but which did not appear in the comment or for which the confidence interval is low. Specific rating questions directed towards those topics identified, narrow and refine the rating process to those areas specifically addressed by the consumer and which matter to the consumer. A set of business rules provided by the user is used to ask additional questions based on the specific ratings and/or additional goods/services for which the user desires specific information.

In one aspect of the technology, statistical analyses are performed regarding the confidence interval of topics identified from the consumer comment. Confidence intervals consist of a range of values (interval) that act as estimates of the unknown population parameter. In this case, the topics identified in a consumer comment constitute the unknown population parameter, though other population parameters may be used. In infrequent cases, none of these values may cover the value of the parameter. The level of confidence of the confidence interval would indicate the probability that the confidence range captures this true population parameter given a distribution of samples. It does not describe any single sample. This value is represented by a percentage. After a sample is taken, the population parameter is either in the interval made or not; it is not a matter of chance. The desired level of confidence is set by the user. If a corresponding hypothesis test is performed, the confidence level is the complement of respective level of significance. That is, a 95 percent confidence interval reflects a significance level of 0.05. The confidence interval contains the parameter values that, when tested, should not be rejected with the same sample. Greater levels of variance yield larger confidence intervals, and hence less precise estimates of the parameter.

In accordance with one aspect of the technology, if the calculated statistical confidence interval does not meet or exceed a user-defined threshold value (e.g., greater than 90 percent) on any of the topics identified, the system prompts the customer to confirm their perceived sentiment with a rating question. For example, if the textual analysis of the consumer comment resulted in a possible negative consumer sentiment with respect to a service, but the confidence interval was below that set by the user, a specific rating question would be generated and posed.

Computer: “You mentioned the cleanliness of the parking lot in your response. Can you rate the cleanliness of the parking lot on a scale of 1 to 5?”

If the confidence interval regarding consumer sentiment of the cleanliness of the parking lot was within an acceptable range, follow up questions ranking the parking lot, for example, would not need to be asked. A rating could be assigned based on the textual analytics of the response. For example, if the consumer said “the parking lot was filthy” a value of 1 may be assigned to the consumer rating without the need of a specific follow-up question. As noted above, if the specific topic was not mentioned by the customer (e.g., the cleanliness of the parking lot), and the user desired to collect information about the parking lot, the survey would generate follow-up questions: “You didn't mention the parking lot. Did you use the parking lot?” After an affirmative answer, a closed-ended question such as “Rate the cleanliness of the parking lot from 1 to 5” may be asked or another open-ended question may be asked such as “What did you think of the parking lot?” In one aspect of the technology, the choice between open or closed-ended questions is a function of user-defined rules setting a value on the topic of interest and the current length of the survey.

In one aspect of the technology, business rules supplied by the user (i.e., the business concern) are applied to dynamically alter the flow of the survey. For example, a rule can be applied that states: “If the respondent answers 4 or higher on the Service Rating, ask them the Favorite Service Attribute question.” A similar rule can be asked for negative responses: “If the respondent answers 3 or lower on the Service Rating, ask them the Least Favorite Service Attribute question.” Similarly, if an open-ended question results in a consumer response that is determined to be negative (e.g., a response using the words “hate” or “gross,” or variations thereof, is detected), a business rule asking specific follow-up questions is implemented.

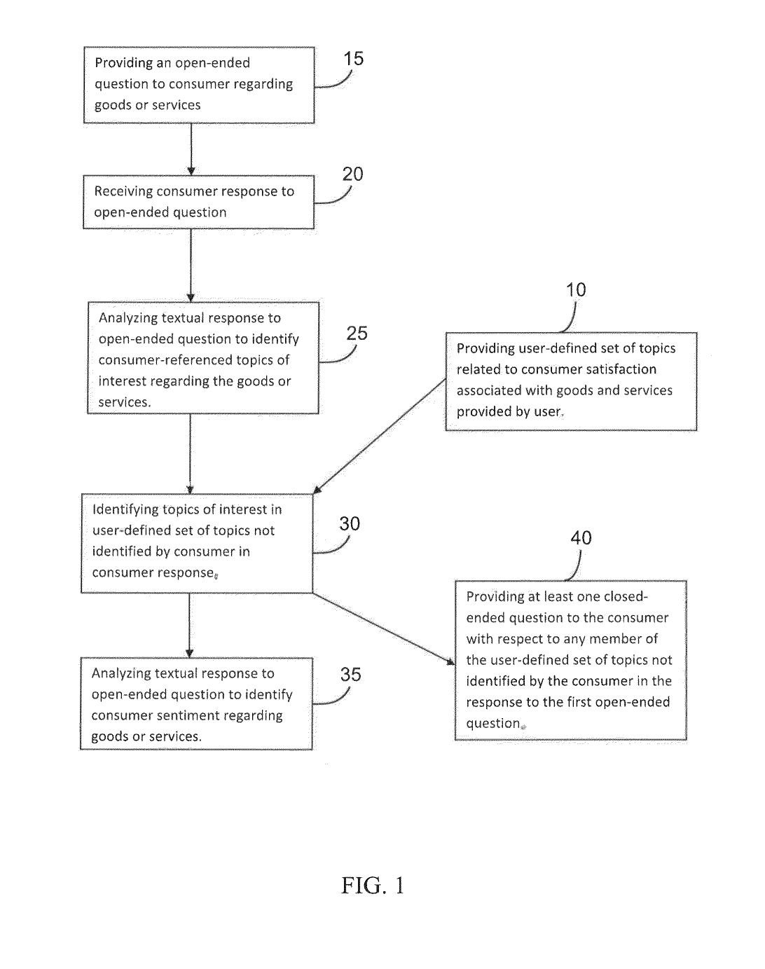

With reference to FIG. 1, in one aspect of the technology, a method for conducting real-time dynamic consumer experience surveys, the method under control of one or more computer systems configured with executable instructions, comprises providing a set of user-defined topics of interest related to a specific good or service provided by the user to a consumer 10. The method further comprises providing a processor configured for providing an open-ended question to the consumer 10 of the specific good or service regarding the consumers 10 experience with said good or service 15, receiving the consumers 10 response to said open-ended question 20, analyzing the text of said response to the open-ended question 20 to identify consumer-identified topics of interest 25, identifying the presence of members of the set of user-defined topics not within the response 30, analyzing the text of said response to the open-ended question 20 to identify sentiment measure regarding said goods or services 35, and providing at least one closed-ended question 40 with respect to any member of the set of user-defined topics not identified in step number 30, wherein said closed-ended question 40 is a function of a predetermined set of rules.

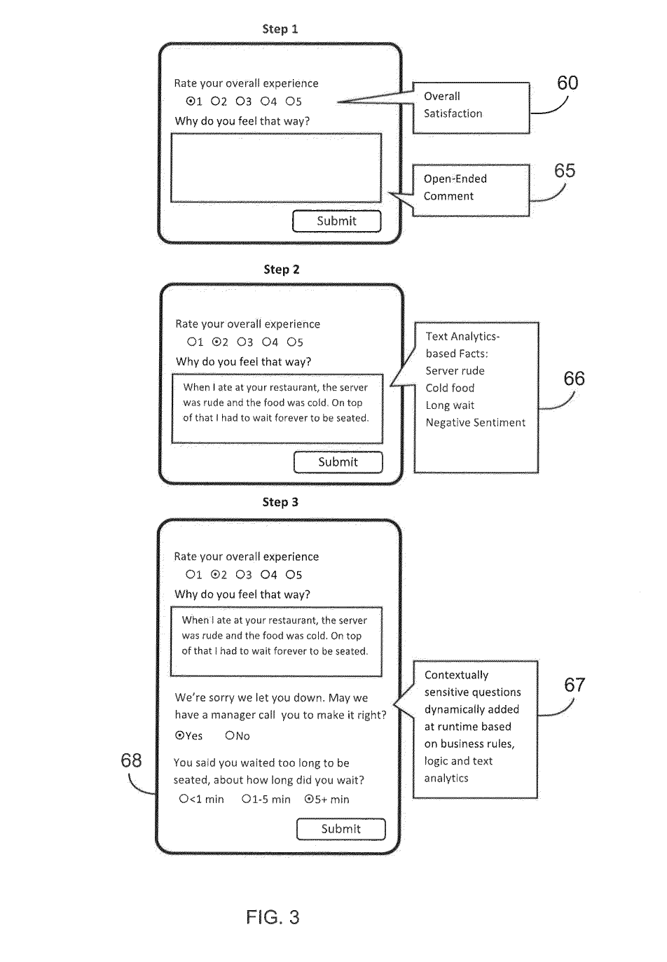

With reference to FIG. 3, in one aspect of the technology, a method for conducting real-time dynamic consumer experience surveys comprises beginning the survey by asking the consumer to provide an overall rating of the experience 60 and prompting the consumer with an open-ended question to explain why he or she provided the specific rating 65. The text of the consumer response (whether entered originally in text format or generated from a voice response) is analyzed using natural language processing, for example, to ascertain consumer-identified topics that correlate to the experience score 66. Contextually sensitive questions are dynamically generated based on user-defined business rules 67. In one aspect of the technology, those rules are industry-specific and are suited to specific business needs. A closed-ended question 68 related to the specific topic identified by the consumer in his or her response is proffered. In one aspect, the closed-ended question 68 is derived from a set of user-defined rules that relate to the topic identified by the consumer. For example, if the consumer indicates they waited too long for a table, a closed-ended question 68 is posed that provides the consumer with an opportunity to provide a structured response.

In another aspect of the technology, deductive survey logic is employed to improve the quality of the comments themselves. In addition to direct open-ended questions to the respondent, the system prompts the user to discuss additional points in their comment as they are typing. This can shorten a survey experience and improve the length and quality of the comment itself. Advantageously, this results in an improved survey experience for the respondent while simultaneously yielding better analytic data for analysis. In many situations, the respondent does not have much incentive to elaborate deeply. For example, if a respondent had a great overall experience, it is not uncommon for the respondent to simply reply in their comment something similar to “everything was great.” In aggregate, these short generalized comments introduce noise into text analysis and produce very little analytic value. Which such short generalized responses are detected, the respondent is prompted to elaborate further on the observation.

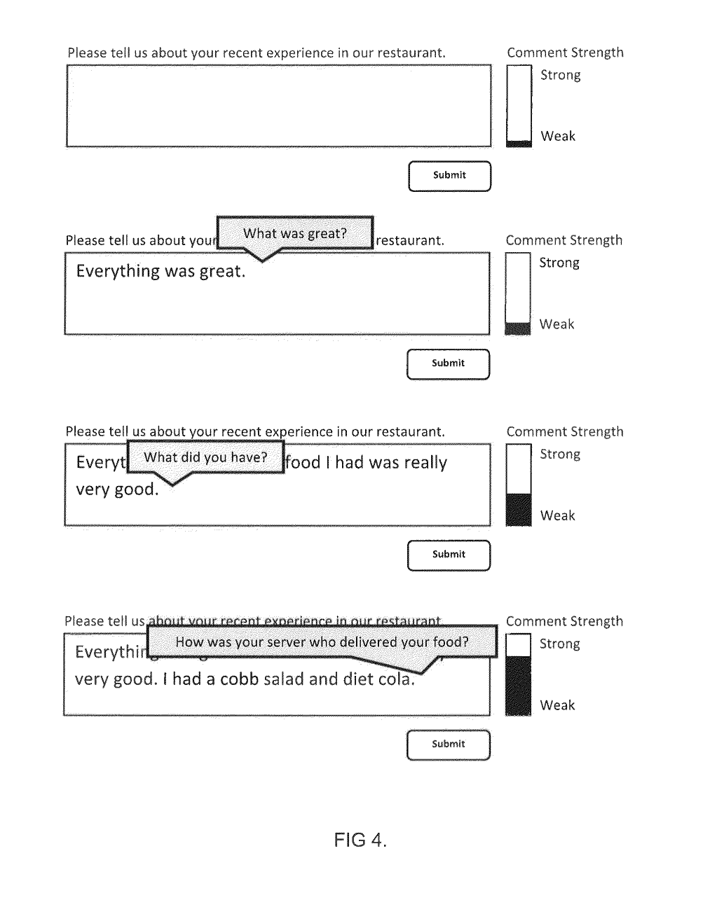

In one aspect of the technology, with reference generally to FIG. 4, if a respondent is asked, “Rate your experience on a scale of 1 to 5,” and the respondent provides a rating of 5, they are asked in an open-ended question to, “Explain in your own words why you feel that way.” They then reply that, “Everything was great.” The system uses custom dictionaries and taxonomies to identify numerous ways of expressing that sentiment. Identifying that the respondent has replied with an overly simplistic phrase, the system prompts the respondent to enrich their comment. For example:

Computer: “Rate your experience on a scale of 1 to 5”

### Respondent: 5

Computer: “Please tell us in your own words why you feel that way.”
Respondent: “Everything was great.”
Computer (prompting): “What was great?”
Respondent (adds): “The food was very good.”
Computer (prompting): “What food did you order?”
Respondent (adds): “I had a cobb salad and a diet cola.”
Computer (prompting): “Tell us about the server who delivered your food.”
Respondent (adds): “The server was pretty nice and made a good menu suggestion.”

In the original comment, no actionable information is given by the respondent. By further prompting using deductive text analytics logic, additional facts including Food Quality, Cobb Salad, Diet Cola, Friendly Service, and Menu Item are acquired. The comment prompts are generated by evaluating the consumer text as he or she enters the answer and provides a contextually appropriate prompt to extract additional useful information. In one aspect of the technology, the quality of the prompts is improved by the use of industry/domain specific text analytics including user-defined business rules, taxonomies, dictionaries, ontologies, hierarchies, and the like. Moreover, the prompts can be driven by text analytic facts acquired from prior elements of the survey, including, but not limited to sentiment analysis, topic analysis, and previously collected structured data (ratings, context data, etc.).

In accordance with one aspect of the technology, a module is employed to significantly increase the value of the comments provided by a consumer in real-time. The term “module,” as used herein, denotes a discrete set of computer implemented instructions that perform a specific function are contained on a special purpose computer. As noted herein, traditionally consumers are invited to share their brand experiences through digital consumer surveys that involve a series of closed- and open-ended questions. In order to extract meaningful data across complex experiences, however, surveys can be tedious and long. When consumers come to an open-ended question, they may give vague or abrupt responses in order to quickly complete the survey. Aspects of the present technology improve consumer response to open-ended questions by analyzing the response in real-time and prompting the consumer with specific follow-up questions, hints, prompts, or suggestions that are customized to the customer's experience and which provide the data analyst with sufficient information to identify an action item; that is, a “something” to be improved upon in order to improve the customer's experience. Generally speaking, the logic employed strives to prompt the consumer to provide enough information in a survey response to achieve an entity/attribute pair for each topical area. That is, the module analyzes the consumer comment in real time and if a given entity lacks an attribute or vice versa, instructions to prompt the consumer for additional information are carried out asking the consumer to provide additional information regarding the missing pair. The terms “entities” and “attributes” are related to categories of grammar, where words are classified according to their function in a sentence. These categories include but are not limited to, a subject and an adjective describing the subject. The subject or “entity” is the driver of a statement, indicating who or what the sentence is about. The adjective or “attribute” describes a state of the “entity.” When identified independently from the sentence to which they were extracted (and/or in the context of the sentence) and seen in combination and correlated together, the combination is referred to herein as an entity/attribute pair.

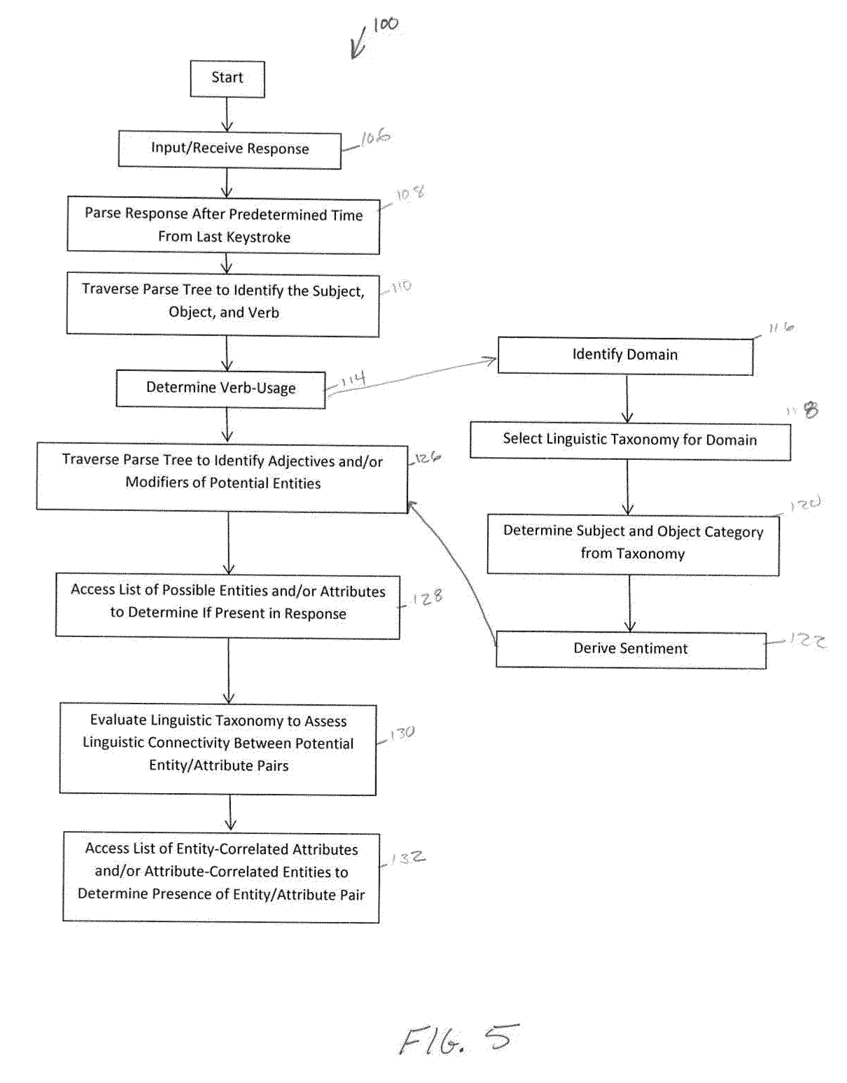

In accordance with one aspect of the technology, textual data in the form of statements and assertions in a given domain are analyzed and aggregated in real time. The domain is a source of data that generally pertains to one or more specific data categories. In one aspect (as applied to consumer experience analysis), a domain may be real-time call-center data for specific products or services with an automated survey administrator. In another aspect, the domain may be an online survey that is administered electronically to a user at a remote location over a computer network. FIG. 5 is a flow chart 100 depicting a process for analyzing and aggregating the textual data. First, a consumer survey is initiated and at some point during the survey, a consumer begins typing a comment to an open-ended question. The open-ended question may be product or service specific (e.g., Please tell us about your experience at McDonald's, etc.) or it may be more generic (e.g., Please tell us about your experience, etc.). The module detects consumer keystrokes and upon the determination that a keystroke has not been completed by the consumer (i.e., the survey respondent) for a predetermined period of time (e.g., 200 milliseconds to 400 milliseconds), the phrase entered by the consumer is analyzed. If no phrase has been entered, the module prompts the consumer to answer the open-ended question. Advantageously, the slight pause after the last keystroke allows the module to process the consumer response in real-time but also improves processor efficiency by eliminating the need to process every keystroke as it happens. Rather, the module processes full thoughts/ideas as they are received.

In accordance with one aspect in the analysis of a response, generic terms are identified and removed from response. The generic terms are those that are listed in a database as providing little or no value to the data analyst. In one non-limiting example, if the consumer entered the phrase “my fries were cold,” the module would eliminate the terms “my” and “were” from the analysis producing only two parsed terms to be analyzed: “fries” and “cold.” In one aspect, the two parsed terms are cross-referenced against a customized database corresponding to the specific service and/or goods belonging to a particular domain (e.g., restaurants, hotels, airlines, etc.) in order to determine if the terms are part of an “attribute” database or an “entity” database. In this instance, the term “fries” is located in the domain-specific database for entities and the term “cold” is located in the domain-specific database for attributes. Where only one entity and one attribute are detected in a phrase, the attribute is cross-referenced with a database correlating to entities commonly associated with the identified attribute. If the attribute parsed from the sentence is located in the correlating database for the identified entity, an entity/attribute pair has been identified and the module moves on to the next open-ended question to the consumer. In one aspect, the attribute is identified first (e.g., cold) and is cross-referenced with a database correlating to attributes associated with the identified entity. The converse, however, is also true in that the entity is identified first and is cross-referenced with a database correlating to entities associated with the identified attribute.

In accordance with one aspect of the technology, parsed terms are categorized into user-defined topics of interest. For example, if the user is a restaurant owner or other service provider, terms identified as entities may be placed a category such as people, product, place, or process. The categories may be more specific, for example, food freshness, friendliness of waiter, cleanliness of kitchen area. Of course, other categories are contemplated for use herein as suits a particular purpose or industry. In one aspect of the technology, this step is conducted prior to other steps detailed herein to improve processor times required to identify entity/attribute pairs. If the consumer response requires more complex analysis, the original response can be analyzed using additional steps described in more detail herein.

In one aspect of the technology, the entities and attributes are customized in a database that is unique to a particular service, industry, or product irrespective of a designated category (i.e., people, product, place, or process). In another aspect, the customized lists are unique to the same retail outlets owned by a particular business unit but that all reside in a specific geography (e.g., all McDonald's restaurants in Northern Utah). One non-limiting example of attribute/entity datasets and correlating datasets for a McDonald's restaurant, for example, are provided below:

| | | User-Defined | |
|---|---|---|---|
| User-Defined | User-Defined | Attributes | User-Defined |
| List of | List of | Correlated with | Entities Correlated |
| Entities | Attributes | “burger” | with “cold” |
| burger | cold | good | burger |
| fries | hot | bad* | fries |
| meat | greasy | cold | coffee |
| service | slow | greasy | table |
| bathrooms | fast | gross | chairs |
| floors | clean | weird* | manager |
| garbage | dirty | funny* | Big Mac |
| Big Mac | funny | stink* | McRib |
| McRib | smelly | taste | food |
| Coffee | clean | small | bathroom |

In certain instances, a consumer's use of certain entity or attribute terms that are correlated with identified entities or attributes does not provide the data analyst with enough information to generate an action item. That is, the attribute correlating to the entity is too vague. For example, the phrase, “My burger was funny” does not provide the data analyst with enough feedback to take action in order to improve the customer experience. The vague terms (shown with an *) symbol are tagged in the database so that when a consumer uses the term, a more specific follow-up question keyed to that phrase is provided to the consumer such as “What was funny about your burger?” or “I am not sure I understand, can you explain more?” In the first example follow-up response, both the identified attribute (funny) and the entity (burger) are included in the follow-up to provide a specific request to the consumer.

In certain instances, phrase taxonomy is utilized to generate follow-up questions to the consumer and/or to evaluate the value of the response. For example, when more than one entity is provided in a response without an accompanying number of attributes, the module will parse the response into component parts to assess the assignment of entities to attributes. One purpose in parsing is the identification of entities and corresponding attributes that are not otherwise readily discernable. With reference to FIG. 5, in one aspect of the technology a block diagram 100 is disclosed illustrating certain steps employed by the technology herein where particular components of human speech such as a noun, object, and verb, are parsed from a phrase entered by a consumer in response 106 to a survey request. The phrase is parsed using a linguistic parser. The parsing of the phrase creates a parse tree which provides a tag for each component in the phrase. Following the phrase parse at step 108, the parse tree is traversed in order to identify the subject, object, and verb 110. Accordingly, the phrase is parsed and the subject, object, and verb in the parsed phrase are identified. The identification of the subject, object, and verb at step 110 forms a low level SVO triplet, e.g. subject, verb, object triplet 112. A linguistic taxonomy of the identified verb in combination with parts of speech within the sentence that establish context of the verb is used to determine a verb-usage pattern in phrase 114. This determined verb usage pattern identifies the context of, and/or the application of, the parsed verb from phrase as well as the presence of any adjectives modifying the noun. The domain from which the data is extracted is identified 116. A linguistic taxonomy is determined for the identified domain 118, and the linguistic taxonomy is used to determine a subject category, an object category derived from the identified subject and object respectively 120, and the presence or lack of presence of a adjective describing the subject. This determined subject category and object category, combined with the determined verb-usage pattern, creates a high level SVO triplet. Following the creation of the high level SVO triplet, a sentiment is derived from the high level SVO triplet 122. In one aspect of the technology, the sentiment is derived from a category of positive, neutral, or negative. The high level SVO triplet, with respect to the derived sentiment, is used to classify the phrase. In one aspect, the classification at step 124 is also referred to as identification of a statement classification.

In accordance with one aspect of the technology, at step 114, after determining verb-usage, the module traverses the parse tree to identify adjectives and/or terms that modify objects located in the response at step 126. A list of possible entities and attributes is accessed and referenced against the objects and/or adjectives identified in the tree 128 to identify potential attribute/entity pairs. In step 130, the linguistic connectivity between potential attribute/entity pairs is evaluated. Where an attribute and entity are determined to be linguistically connected, the module cross-references each attribute and entity against a dataset having attribute-correlated entities and entity-correlated attributes to determine whether an entity/attribute pair is present 132. If there is no connectivity, follow-up questions are posed to the consumer to generate an entity/attribute pair.

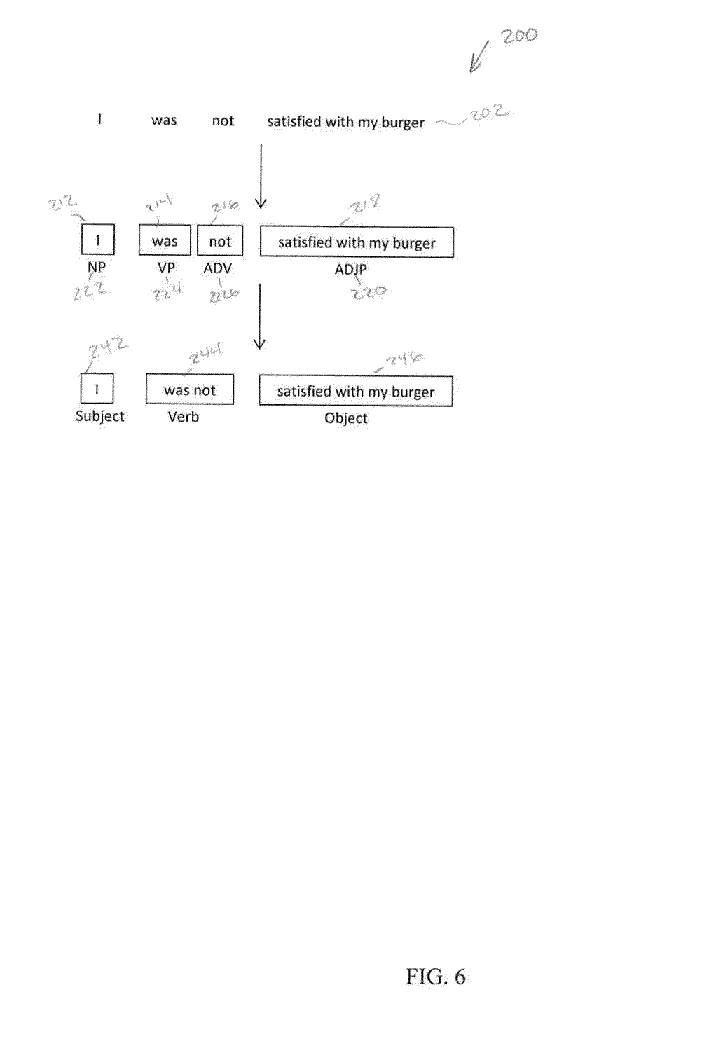

To further illustrate the aspects taught in FIG. 5, examples are provided to demonstrate textual evaluation. FIG. 6 is a block diagram 200 illustrating a first example for developing a statement cluster from an extracted phrase. A simple sentence “I was not satisfied with the burger.” 202 is parsed. As shown, when parsing the extracted sentence parts of speech of the sentence are separately identified. In this example, the parsing determines “I” 212 as a noun phrase 222, “was” 214 as a verb phrase 224, “not” 216 as an adverb 226, and “satisfied with the burger” 218 as an adjective phrase 220. Verb usage is evaluated to ascertain the linguistic taxonomy. In one aspect, the join includes mapping the verb-usage pattern to the verb to ascertain the meaning of the parsed sentence. The join shows the following identified components of the sentence: the subject “I” 242, verb “was not” 244, and object “satisfied with the burger” 246. These components in combination are regarded as a low level SVO triplet. A domain-specific taxonomy is used to determine a subject category “customer” derived from the subject “I”, and/or an object category “product:burger” derived from the object “satisfied with the burger.” A verb category “constitute” is determined by the verb usage pattern. More specifically, the categorization of the verb is in response to the identified verb usage pattern and based on a reference to an existing linguistic resource to provide a mapping from the verb usage pattern to the categorization of the verb. The linguistic resource provides the mapping from the verb usage pattern to the categorization of the verb. Linguistic taxonomy is used to identify the subject category, object category, and verb category. Sentiment is derived from the subject category, object category, and verb category. The verb category, subject category, and object category in combination is regarded as a high level SVO triplet. In this example the derived sentiment is negative as determined from the high level SVO triple. A statement classification indicating “customer feedback on hamburger” is identified based on one or more the following: the subject category “customer,” the verb category “constitute”, the object category “product: burger”, and the derived sentiment. Accordingly, a classified statement having a high level SVO triplet and a derived sentiment are determined from the example phrase. Based on the SVO triplet, linguistic taxonomy can be used to identify adjectives or other terms that modify the object and/or the linguistic connectivity between objects and adjectives identified in a phrase. In one aspect, identified objects are tagged as potential entities and terms that modify the object are tagged as potential attributes.

In the example noted above, while a negative sentiment is identified, there is no identifiable action item resulting from the parsed data. That is, the term “burger” can be identified as an “entity” of interest to the user, but there is no correlating attribute or no data as to why the consumer did not like their burger. In accordance with one aspect, when an entity is identified and no correlated attribute is present, the consumer is prompted with a simple “Please tell us more about your burger?” or “How could your burger be better?” However, based on the negative sentiment extracted from the phrase, a more specific and valuable question can be posed: “Please tell us why you didn't like your burger.”

The module also analyzes sentence structure in order to assign entities and attributes that are combined in a more complex manner. For example, in the response “Everything was fine, but my fries and burger were a little greasy and the bathroom could be cleaner,” the phrase “everything was fine” is identified as having a positive sentiment, but the remaining portions of the sentence have a negative sentiment. Additionally, the entities “fries” and “burger” are both associated with the attribute “greasy” and the entity “bathroom” is associated with the attribute “cleaner.” In this example, however, understanding sentence taxonomy is important to properly understanding whether a follow-up response is necessary or whether the data analyst will be able to extract sufficient information from the consumer response to generate an action item. Additionally, a non-sensical follow-up response will confuse the consumer and incentivize them to simply speed through remaining questions creating concerns with the validity and value of the response. Dissecting the phrase into its component parts, the module identifies the sentence taxonomy so that “burgers” and “fries” are identified as an object of the sentence and “greasy” is identified as an adjective corresponding to both the connective verb “were.” The phrase “bathrooms could be cleaner” is also parsed into its component parts where “bathroom” is the object, “could be” is identified as the verb phrase, and “cleaner” is identified as an adjective modifying the object “bathroom.” The objects of the phrase are cross-referenced with the customized datasets to be tagged as important and relevant to the particular user (e.g., a restaurant owner). In this instance, all the objects appear in the entity list that is designated by the user. Based on the taxonomy of the sentence, the adjectives that correspond to the sentence object are cross-referenced to those specific objects to be potentially identified as corresponding attributes of the identified entities. In this aspect, the phrase “greasy” is taxonomically connected to two objects (identified as entities in this example). Because “greasy” is correlated in the customized attributes dataset with both “burger” and “fries”, the module recognizes that an entity/attribute pair has been created for each of the “burger” and “fries” entities even though only a single attribute was present in the response. The object “bathroom” is taxonomically connected to the phrase “cleaner” through the connecting verb “could be” and, as such, the two are identified as a potential entity/attribute pair. Once entities are paired up with taxonomically connected attributes, the module cross-references the customized attributes dataset to determine if the attribute appears in the list correlated to the identified entity (or vice versa). In this instance, the root term “clean” is a listed attribute correlated with the entity “bathroom” and thus “bathroom” and “clean” are identified as an entity/attribute pair. Once this information is procured, the module moves on to another open-question or, in some instances, terminates the survey. It is important to note that in this aspect, the module is not determining whether the consumer believed the bathrooms were clean or not clean. Rather, the module functions to ensure that meaningful data is procured from the consumer taking the survey.

In another example of open-ended questions based on response taxonomy and entity/attribute pairing, the module is constructed to distinguish between entities and attributes that may not correlate with one another. That is, the module is constructed to identify entity/attribute pairs, not just the existence of an entity and an attribute in the same response. In one non-limiting example, a consumer may provide a vague response such as “Problems with manager and smell.” While the terms “manager” and “smell” are categorically identified as an entity and attribute, in this example the two are not related to one another. That is, they do not form an entity/attribute pair. The module parses the response identifying “manager” and “smell” and cross-references each term with the customized entity/attribute dataset for a match. In this instance, the term “manager” is not listed as a possible entity in the “smell” attribute category and neither is the term “smell” listed as a possible attribute in the “manager” entity category. As such, two possible follow-up questions, hints, or suggestions (i.e., any prompt) can be generated. For example, a series of prompts and responses might look like the following:

Computer: “In your owner words, tell us about your overall experience.”
Respondent: “Everything was ok, I guess.” [No entity or attribute detected]
Computer (prompting): “Could you please be a little more specific?” [Generic prompt to elicit additional information]
Respondent: “Problems with manager and smell.” [An entity “manager” and attribute “smell” detected, but not paired]
Computer (prompting) “Could you tell us more about the manager?”
Respondent: “He was a jerk.” [attribute “jerk” paired with entity “manager”]
Computer (prompting) “We are sorry about that. Tell us more about your problem with the smell.”
Respondent: “The bathroom smelled gross” [attribute “gross” paired with entity “smell/gross” ]

In the example provided above the terms “smell” and “manager” were not correlated and therefore not identified as an entity/attribute pair prompting specific follow-up questions. However, in some instances, the consumer may indeed have intended to convey that the manager had a foul odor. This would be apparent from the consumer response to the follow up question. In the instance where the same or similar attribute is repeated for the same entity (or vice versa), the module classifies the response as having an entity/attribute pair even though the terms are not correlated in the attribute or entity correlated datasets. The following questions present one non-limiting example of the same:

Respondent: “I had problems with manager and smell.” [An entity “manager” and attribute “smell” detected, but not paired]
Computer (prompting) “Could you tell us more about the manager?”
Respondent: “He stunk.” [attribute “stunk” paired with entity “manager”]

In accordance with on aspect of the technology “entities” and/or “attributes” that appear in numerous formats are correlated together to minimize processing time and/or the need for multiple entries in the correlation table. For example, the terms “stink, stank, stunk, stinky, stinks, stinking, smell, smelly,” all convey a similar impression from the consumer (i.e., the consumer was unhappy with a product or a location had a foul smell). The meaning of the term would be determined based on the linguistic taxonomy. However, when a term is entered that has a plurality of corresponding formats, the processor parses or construes the term into its root form (in this instance the term stink) prior to looking up the term in the entity/attribute/correlation table. In the example listed above with respect to the terms “manager” and “smell”, even though the consumer responds with the term “smell” in his first response and “stink” in his second, the module recognizes the two terms as conveying a similar meaning. While specific reference is made to “questions” herein, it is understood that in certain circumstance any appropriate prompt (i.e., an open-ended or closed-ended question, hint, suggestion, etc.) that will elicit additional information from a consumer may be used.

In yet another example of sentence taxonomy, a response to an open-ended question regarding a consumer experience may be “The food stunk and the bathrooms were dirty.” Using linguistic correlative techniques alone (i.e., decision logic comparing only core terms in a sentence with one another), a module may determine that the entity “bathroom” was paired with the attributes “dirty” and “stinky” as both of those terms may appear in the attribute correlation column for the term “bathroom.” In that scenario, the entity “food” may also be paired with the attributes “dirty” and “stinky” though lacking an attribute pair. Based on the linguistic taxonomy of the sentence, however, the term “food” is identified as being modified by the term “stinky” and the term “bathroom” is identified as being modified by the term “dirty.” That is, by parsing the sentence into an SVO triplet and assessing term proximity to other terms in the phrase, potential entity/attribute pairs are identified. Once a potential pair is identified, the correlation tables (e.g., the above-referenced datasets) are accessed by the module to determine whether user-defined terms appear in the response resulting in an entity/attribute pair. In a similar example, if a survey response from a consumer was “The bathroom stunk and I didn't like the food,” the module would parse the sentence to create SVO triplets. Based on linguistic taxonomy, the term “bathroom” is identified as a potential entity and “stunk” as a potential attribute and cross-referenced in the user-defined datasets. The term “food” is identified as a potential entity but no potential attribute is identified. In one aspect, once the module determines that the term “food” is listed in the user-defined datasets as an entity of interest and a negative sentiment is derived from the SVO triplet and follow-up response is generated such as “Can you tell us why you didn't like the food?” Again, the response is parsed and evaluated for entity/attribute pairs or at least until an attribute corresponding to the entity identified in the original response is identified in a subsequent response.

In accordance with one aspect of the technology, the module is constructed such that no attempt is made to pair irrelevant entities or attributes (i.e., entities or attributes that the user has not identified as presently meaningful). In this manner, specific follow-up questions can be tailored to identify and address those topics of interest and effectively ignore others.

This improves the efficiency of the module and improves processor speed. In one non-limiting example a response might be “The employee uniform was stupid.” However, the user has not selected employee uniform as being important to overall customer satisfaction. Indeed, the user may have utilized other tools to determine that changes to employee uniforms had little to no effect on overall consumer sentiment related to goods and/or services. In this instance, no analysis is completed to identify whether an entity/attribute pair is present in the response nor a follow-up question generated in order to create an entity/attribute pair. Rather, an additional open-ended question that is directed to a hierarchical list of user-defined topics is provided. For example, in response to the comment noted above the module might generate the following: “Thanks for you feedback. Did you enjoy the food?”

In one aspect of the technology, if an entity or attribute is not present in response to survey question, a specific open-ended question that is correlated to identified key drivers are generated. That is, in one aspect, a plurality of closed-ended questions are first administered to a consumer asking the consumer to rate certain identified key drivers. Open-ended questions are then provided to the consumer directed to the key drivers identified as having the lowest rank until an entity/attribute pair is identified. For example, the following questions might be presented to a consumer:

Computer: “Rate the quality of food on a scale of 1 to 5, 1 being lowest and 5 being highest.”

### Respondent: 5

Computer: “Rate the quality of service on a scale of 1 to 5, 1 being lowest and 5 being highest.”

### Respondent: 1

Computer: “In your owner words, tell us about your overall experience.”
Respondent: “Everything was fine.” [No entity or attribute detected]
Computer (prompting): “You mentioned that you were not very satisfied with the service, can you tell us why?” [Open-ended question directed to lowest ranked key driver]
Respondent: “I didn't like the waitress.” [Entity detected, but no attribute]
Computer (prompting): “Sorry about that. Can you tell us why you didn't like the waitress?”
Respondent: “She was too slow.” [Entity/Attribute Pair detected]

In another aspect of the technology, a plurality of closed-ended questions are posed to a consumer regarding user-identified key drivers (i.e., those that are most important to the user). As noted herein, once key drivers are identified, the importance of each key driver with respect to incremental improvements on the PPI is determined. That is, if drivers were rated from 1 to 5, moving an individual driver (e.g., quality) from a 2 to a 3 may be more important to the overall PPI than moving an individual driver (e.g., speed) from a 1 to a 2. When potential incremental improvement is estimated, key driver ratings for surveys are evaluated to determine the net change in the PPI based on incremental changes (either positive or negative) to key drivers. Open-ended questions are then directed towards the key drivers that are determined as having the greatest probability as improving the overall PPI. In one aspect, where there is no clear key driver having the greatest impact in improving the overall PPI, a key driver is randomly selected and an open-ended question is directed towards the randomly selected key driver. In another aspect, a combination of the user-identified key driver and lowest scoring driver may be used to generate a prompt. For example, a user may have identified bathroom cleanliness as the most important key driver, but the module may be configured such that any driver receiving a rating below a threshold level (e.g., less than 2) may generate a prompt.

Visual Display

Numerous styles of visual prompts are contemplated for use herein. In one aspect, a prompt box or bubble appears in close proximity to the consumer's text as they type a comment. The prompt box includes the prompt that assists the consumer in providing additional information. In yet another aspect, a “comment strength” indicator visually cues the consumer as to how useful the comment is perceived. As many consumer surveys are linked to incentives for completing a survey, in one aspect, incentives may be increased for stronger consumer comments. In one aspect of the technology, the “submit” button enabling the consumer to complete the survey is not activated, until the “comment strength” indicator reaches an acceptable level. In yet another aspect, the advancement of the “comment strength” indicator is dependent upon the response including an entity/attribute pair. That is, in addition to follow-up responses eliciting additional data from a consumer in order to pair entities with attributes, the consumer is presented with a visual indicator of the response to help the consumer understand the relative value of the comment. This trains survey takers to respond with entity/attribute pairing in subsequent responses. In one aspect, the comment strength indicator advances one level when any type of response is provided, advances a second level when an entity or attribute is detected in the response, and advances to a third or final level when an entity/attribute pair is detected.

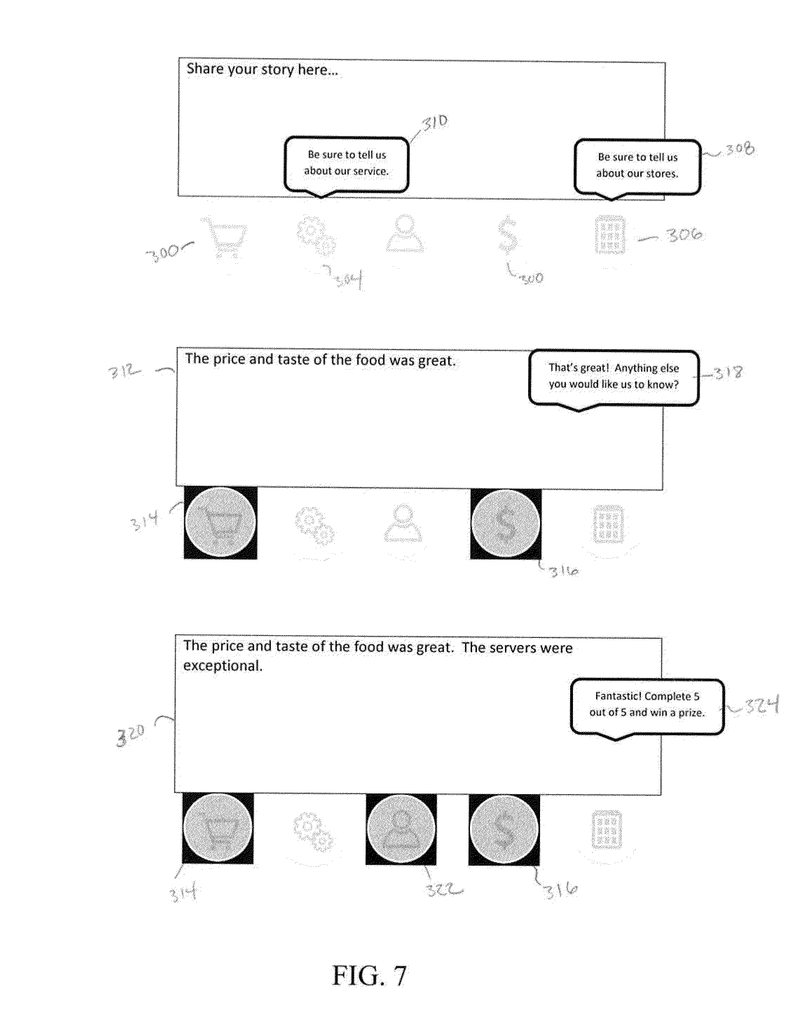

With reference generally to FIG. 7, in accordance with one aspect of the technology, a plurality of interactive features are presented to the consumer in an effort to incentivize them to comment on user-defined topics of interest and/or to achieve an attribute/entity pair in the response. In one aspect, a plurality of icons 300 are displayed below the response box 302. Each of the icons 300 corresponds to a different topic of interest to the user (i.e., the business owner). For example, icon 304 corresponds to service and icon 306 corresponds to the storefront. When a consumer mouses over the icon, a pop-up box 308, 310 appears prompting the customer to talk about specific topics. In the comment box 312, the consumer has responded with two complete entity/attribute pairs corresponding to the price and the taste of the food. In this aspect, a complete entity/attribute pair is identified with respect to one of the icons, a visible change in the icon occurs. For example, icon 314 and 316 are highlighted indicating that the consumer has addressed those areas or provided information desired by the user. An audible indicator (e.g., cheering, etc.) and other visual indicators (e.g., animation, etc.) may be included. In addition, a pop-up box 318 is provided encouraging the consumer to provide additional information. In comment box 320, the consumer provides another complete entity/attribute pair with his/her comment resulting in another icon 322 being highlighted. A pop-up box 324 appears encouraging the consumer to complete all five.

In accordance with one aspect of the technology, methods and systems are employed to identify consumer comments that convey information regarding attributes of third-party goods and/or services and thereafter identify a potential source of the third-party goods and/or services provided to the consumer. Broadly speaking, in one non-limiting example where a restaurant serves salad that it purchases from a third-party vendor, if a consumer indicates that the lettuce in its salad had a worm in it, the system flags the comment as having a negative sentiment associated with the salad but also flags the comment as having an attribute related to an entity that has been previously tagged as corresponding to third-party goods. That is, all goods (i.e., entities) that are provided to a particular retailer that are listed in an entity list identified by the module during a consumer response are tagged as originating from a third-party source. When negative sentiment is detected in connection with the particular good and an action item is identified, a vendor tracking module is accessed based on the parsed term “salad” that tracks what third-party provided the salad to the specific retail outlet. In one aspect, the vendor tracking module is activated when an entity/attribute pair are completed and the entity is tagged as originating from a third-party source. The vendor tracking module accesses a dataset corresponding to the delivery date of the product to the retailer and the name of the vendor and generates a notification to the user that a negative comment has been received regarding the product from the vendor indicating the content of the negative comment. In accordance with one aspect of the technology, the vendor tracking module is activated only when an entity/attribute pair is identified and the attribute corresponds to a subset of action items that are the result of vendor actions, not the result of retailer actions. In one non-limiting example, where the customer complains that there was a worm in its salad, the “attribute” worm is tagged as being the result of vendor action, not retailer action. In contrast, if the customer complains that the salad had too much dressing or was warm, the identified attributes would not be tagged as resulting from vendor actions.

The methods and systems described herein may be used in connection with a network comprising a server, a storage component, and computer terminals as are known in the art. The server contains specialized processing components and specialized software and/or hardware components for implementing the consumer survey. The server contains a processor for performing the related tasks of the consumer survey and also contains internal memory for performing the necessary processing tasks. In addition, the server may be connected to an external storage component via the network. The processor is configured to execute one or more software applications to control the operation of the various modules of the server. The processor is also configured to access the internal memory of the server or the external storage to read and/or store data. The processor may be any conventional general purpose single or multi-chip processor as is known in the art. Different combinations of the numerous different aspects described in this application may be combined and/or separately utilized as suits a particular application.

The storage component contains memory for storing information used for performing the consumer survey processes provided by the methods and apparatus described herein. Memory refers to electronic circuitry that allows information, typically computer data, to be stored and retrieved. Memory can refer to external devices or systems, for example, disk drives or other digital media. Memory can also refer to fast semiconductor storage, for example, Random Access Memory (RAM) or various forms of Read Only Memory (ROM) that are directly connected to the processor. Computer terminals represent any type of device that can access a computer network. Devices such as PDA's (personal digital assistants), cell phones, personal computers, lap top computers, tablet computers, mobile devices, or the like could be used. The computer terminals will typically have a display device and one or more input devices. The network may include any type of electronically connected group of computers including, for instance, Internet, Intranet, Local Area Networks (LAN), or Wide Area Networks (WAN). In addition, the connectivity to the network may be, for example, remote modem or Ethernet.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Several non-limiting examples of “modules” are presented below. The structure of the modules is not intended to be expressly limiting to the claims. Rather, they are intended to provide examples of how the technology may be employed on a special purpose computer (i.e., a computer programmed with to perform particular functions pursuant to instructions from program software.).

### Question and Response Generation Module

public String getHint(NudgeRequestDTO smartCommentRequest, NudgeResponseDTO
response, SurveyLanguage lang, Trace t, SmartCommentWebhookInfo scwi, IResponse
surveyResponse){
String hint = null;
if(smartCommentRequest.getHintingType( ) ==
CommentPromptHintingEnum.FULL.ordinal( ) &&
smartCommentRequest.getPearModelId( )!=null){
PearModel pearModel =
smartCommentService.load(PearModel.class,smartCommentRequest.getPearModelId( ));
int count = 0;
if(pearModel!=null){
List<SmartCommentAnnotationMapping> annotationMappings = null;
if(CollectionUtils.isNotEmpty(pearModel.getActiveListeningMappings( ))) {
annotationMappings = pearModel.getActiveListeningMappings( );
} else {
t.start(“load annotation mappings”);
annotationMappings =
smartCommentService.getAnnotations(pearModel.getPear( ));
t.stop( );
}
IComment comment = new Comment( );
String commentText = smartCommentRequest.getText( );
t.addInfo(“Smart Comment Text”, commentText);
t.record( );
comment. setText(commentText);
t. start(“analyzeAndTagResponse”);
Language language = LanguageMapping.getLanguage(lang);
Set<TagAnnotation> annotations =
textAnalysisService.analyzeAndTagResponse(surveyResponse, comment, language,
pearModel, null, new Long(smartCommentRequest.getServerTimeoutMs( )-200), false);
if(CollectionUtils.isNotEmpty(annotations) ){
count = 0;
if(t.isDebugEnabled( )) {
for(TagAnnotation tagAno : annotations) {
t.addInfo(“ Annotation ”+(count++), tagAno);
t.record( );
}
List annotationList = new ArrayList( );
annotationList. addAll(annotations);
if(scwi!=null)scwi.setTagAnnotations(annotationList);
}
t.stop( );
t.start(“determine hint”);
if(CollectionUtils.isNotEmpty(annotations)){
int largestEndIndex = 0;
HashMap<AnnotationCategory, List<SmartCommentAnnotationMappingTagPair>>
categoryToAnnotations = new HashMap<>( );
for(TagAnnotation tagAnnotation:annotations){
if( tagAnnotation.getEndIndex( ).intValue( )>largestEndIndex){
largestEndIndex = tagAnnotation.getEndIndex( ).intValue( );
}
if(tagAnnotation.isAdHoc( )) {
AdHocUse use = tagAnnotation.getTag( ).getAdHocUse( ) != null ?
tagAnnotation.getTag( ).getAdHocUse( ) : AdHocUse.NONE;
String question = “”;
if(use == AdHocUse.PRODUCT) {
try {
String trigger = commentText.substring(tagAnnotation.getBeginIndex( ).intValue( ),
tagAnnotation.getEndIndex( ).intValue( ));
question =
surveyLanguageDbMessageSource.getMessage(MESSAGE_PREFIX+use.name( ), new
Object[ ] {trigger}, lang.getLocale( ));
t.addInfo(“ Question ”, question);
t.record( );
} catch (IndexOutOfBoundsException e) {
errorLogService.log(new ErrorLogEntryBuilder(“Error getting hint for ad hoc tag.”, e)
.add(“commentText”, commentText)
.add(“tag”, tagAnnotation.getTag( ).getName( )+”(“+tagAnnotation.getTagId( )+”)”)
.add(“beginIndex”, tagAnnotation.getBeginIndex( ))
.add(“endIndex”, tagAnnotation. getEndIndex( ))
.setUnhandled(false)
);
}
if(StringUtils.isNotBlank(question)) {
SmartCommentAnnotationMapping mapping = new SmartCommentAnnotationMapping( );
mapping.setAnnotation(tagAnnotation.getAnnotation( ));
mapping.setAnnotationType(AnnotationType.ENTITY);
mapping.setCategory(AnnotationCategory.PRODUCT);
mapping.setQuestion(question);
addMapping(mapping, categoryToAnnotations, tagAnnotation);
}
} else {
for(SmartCommentAnnotationMapping mapping: annotationMappings) {
if(mapping.getAnnotation( ).equals(tagAnnotation.getAnnotation( ))){
if(!SurveyL anguage.ENGLISH. equals (lang) &&
mapping.getActiveListeningQuestions( ).isEmpty( )) {
mapping = genericService.load(SmartCommentAnnotationMapping.class, mapping.getId( ));
}
mapping = new SmartCommentAnnotationMapping(mapping);
Tag tag = tagAnnotation.getTag( );
if(tag.getOrganization( ) == null) {//When using global tags, the type and category are only
used from the tag mapping.setAnnotationType(tag.getActiveListeningAnnotationType( ));
mapping.setCategory(tag.getActiveListeningAnnotationCategory( ));
}
if(mapping.getCategory( ) != AnnotationCategory.NONE) {
addMapping(mapping, categoryToAnnotations, tagAnnotation);
}
break;
}
SmartCommentCategoryResult allResult =
checkHasEntityAttributes(categoryToAnnotations.get(AnnotationCategory.ALL),
largestEndIndex, lang);
if(!allResult.hasAttribute ∥ !allResult.hasEntity) {
for(AnnotationCategory category : AnnotationCategory.values( )) {
if(category == AnnotationCategory.ALL ∥ category == AnnotationCategory.NONE)
continue;
SmartCommentCategoryResult catResult =
checkHasEntityAttributes(categoryToAnnotations.get(category), largestEndIndex, lang);
catResult.hasAttribute = catResult.hasAttribute ∥ allResult.hasAttribute;
catResult.hasEntity = catResult.hasEntity ∥ allResult.hasEntity;
if(catResult.hasAttribute != catResult.hasEntity) {
if(StringUtil.isNotBlank(catResult.hint)) {
hint = catResult.hint;
if(catResult.foundIndex!=null && scwi!=null)
scwi.setMappingTagPair(categoryToAnnotations.get(category).get(catResult.foundIndex.int
Value( )));
} else {
hint = allResult.hint;
if(allResult.foundIndex!=null && scwi!=null)
scwi.setMappingTagPair(categoryToAnnotations.get(AnnotationCategory.ALL).get(allResult
.foundIndex.intValue( )));
}
if(StringUtil.isNotBlank(hint)) break;
}
t. stop( );
}
return hint;
}

### Prompt Follow-Up Module

hintingTimerSetup = function(curStrength) {
clearTimeout(timer);
// Get the last character entered
// Select timeout based on
var charAtEnd = prompt.val( ).charAt(prompt.val( ).length-1);
var formattingChar = [“.”, “ ”, “!”, “?”, “,”, “-”];
var time;
time = (formattingChar. indexOf(charAtEnd) ! = −1) ?
hintingEngine.config.typingTimeoutFormatterCharMs :
hintingEngine.config.typingTimeoutMs;
if(hintingEngine.canHint(curStrength, hasHint)) {
timer = window.setTimeout(
function( ) {
if(!hasHint) hintingEngine.getHint(prompt.val( ), language, pearModelId,
hintCallback,false,isMobile);
},
time);
} else if(hasHint) {
hasHint = false;
};

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description describes the technology with reference to specific exemplary aspects. However, it will be appreciated that various modifications and changes can be made without departing from the scope of the present technology as set forth in the appended claims. The detailed description and accompanying drawing are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the invention should be determined solely by the appended claims and their legal equivalents, rather than by the descriptions and examples given above.

1. A system for administering real-time dynamic consumer surveys, the system under control of one or more computer systems configured with executable instructions, comprising:
a user-defined data storage containing a user-defined list of entities;
a user-defined data storage containing a user-defined list of attributes;
a user-defined data storage containing user-defined entities corresponding to individual attributes in the user-defined list of attributes;
a user-defined data storage containing user-defined attributes corresponding to individual entities in the user-defined list of entities;
a processor;
a memory device including instructions that, when executed by the processor, causes the processor to execute:
an prompt generation module that provides prompt over a network to a consumer of the specific good or service located remotely from the processor, the prompt being directed to the consumer's experience with said good or service;
a consumer response module that (i) analyzes the text of a response received from the consumer to the prompt, (ii) parses the text of the response into component parts, (iii) accesses the user-defined data storage containing a user-defined list of entities to determine if any component parts of the text of the response correspond to any of the list of entities, and (iv) accesses the user-defined data storage containing a user-defined list of attributes to determine if any component parts of the text of the response correspond to any of the list of attributes;
wherein if the consumer response module determines that a user-defined attribute is located in the response, the consumer response module accesses the data storage containing user-defined entities corresponding to individual attributes to determine if an entity corresponding to the located user-defined attribute is present in the response;
wherein if the consumer response module determines that a user-defined entity is located in the response, the consumer response module accesses the data storage containing user-defined attributes corresponding to individual entities to determine if an attribute corresponding to the located user-defined entity is present in the response;
wherein if the consumer response module determines that a user-defined attribute is located in the response and an entity corresponding to the user-defined attribute is not located in the response, a prompt follow-up module generates a follow-up prompt prompting the consumer to provide additional information regarding the located attribute; and
wherein if the consumer response module determines that a user-defined entity is located in the response and an attribute corresponding to the user-defined entity is not located in the response, the prompt follow-up module generates a follow-up prompt prompting the consumer to provide additional information regarding the located entity.

2. The system of claim 1, wherein if the consumer response contains both a user-defined entity and a user-defined attribute, the consumer response module analyzes the consumer response to assess linguistic connectivity between the attribute and the entity.

3. The system of claim 2, wherein the consumer response module analyzes the consumer response and parses the response into component parts to identify a subject, object, and verb within the response.

4. The system of claim 3, wherein the consumer response module analyzes the consumer response and parses the response into component parts to identify an adjective in the response.

5. The method of claim 3, wherein the consumer response module analyzes the consumer response identify a sentiment measure regarding said goods or services

6. The system of claim 1, wherein if the consumer response module locates a user-defined attribute, the prompt follow-up module generates a closed-ended question directed to a located attribute.

7. The system of claim 1, wherein if the consumer response module locates a user-defined entity, the prompt follow-up module generates a closed-ended question directed to a located entity.

8. The system of claim 6, wherein the closed-ended question comprises a request to rate consumer sentiment with respect to the located attribute.

9. The system of claim 7, wherein the closed-ended question comprises a request to rate consumer sentiment with respect to the located entity.

10. The system of claim 1, further comprising the step of providing a plurality of icons on a computer display of the consumer, each icon corresponding to a user-defined topic of interest corresponding to the consumer's experience with the specific goods or services, wherein if the consumer response module determines that an entity/attribute pair is present in the consumer response, the consumer response module determines if the entity/attribute pair corresponds to one of the user-defined topics corresponding to one of the plurality of icons.

11. The system of claim 10, wherein if the consumer response module determines that the an entity/attribute pair corresponding to one of the user-defined topics corresponding to one of the plurality of icons is present in the response, the consumer response module causes the visual appearance of the icon corresponding to said user-defined topic to be modified.

12. A system for administering real-time dynamic consumer surveys, the system under control of one or more computer systems configured with executable instructions, comprising:
one or more user-defined data storage units containing a user-defined list of entities, a user-defined list of attributes, a user-defined data storage containing user-defined entities corresponding to individual attributes in the user-defined list of attributes, and a user-defined data storage containing user-defined attributes corresponding to individual entities in the user-defined list of entities;
a processor coupled to the user-defined storage units;
a memory device including instructions that, when executed by the processor, causes the processor to execute:
(a) a closed-ended question generation module that provides a closed-ended question over a network to a consumer of a specific good or service located remotely from the processor, the closed-ended question being directed to a user-defined topic related to the consumer's experience with the specific good or service;
(b) an open-ended question generation module that provides an open-ended question over the network to the consumer of the specific good or service, the open-ended question being directed to the consumer's experience with said good or service;
(c) a consumer response module that (i) analyzes the text of a response received from the consumer to the open-ended question, (ii) parses the text of the response into component parts, (iii) accesses the user-defined data storage unit containing the user-defined list of entities to determine if any component parts of the text of the response correspond to any of the list of entities, and (iv) accesses the user-defined data storage containing the user-defined list of attributes to determine if any component parts of the text of the response correspond to any of the list of attributes;
(d) wherein the consumer response module determines if a user-defined entity or a user-defined attribute are present in the response; and
(e) wherein if the consumer response module fails to locate a user-defined entity or a user-defined attribute, a question follow-up module provides an open-ended question to the consumer directed to the user-defined topic used in the closed-ended question.

13. The system of claim 12, wherein the consumer response module is configured to detect the time between consumer keystroke's and to analyze the text of the consumer's response to the open-ended question only after a predetermined period of time has passed from the consumer's last keystroke.

14. The system of claim 12, following the open-ended follow-up question in element (d),
if the consumer response module determines that a user-defined attribute is located in the response, the consumer response module accesses the data storage unit containing user-defined entities corresponding to individual attributes to determine if an entity corresponding to the located user-defined attribute is present in the response;
if the consumer response module determines that a user-defined entity is located in the response, the consumer response module accesses the data storage unit containing user-defined attributes corresponding to individual entities to determine if an attribute corresponding to the located user-defined entity is present in the response;
if the consumer response module determines that a user-defined attribute is located in the response and an entity corresponding to the user-defined attribute is not located in the response, a question follow-up module generates a follow-up question prompting the consumer to provide additional information regarding the located attribute; and
if the consumer response module determines that a user-defined entity is located in the response and an attribute corresponding to the user-defined entity is not located in the response, a question follow-up module generates a follow-up question prompting the consumer to provide additional information regarding the located entity.

15. The system of claim 14, wherein a plurality of terms within the user-defined data storage units are tagged as yielding insufficient information to the user of the system.

16. The system of claim 15, wherein if the consumer response module determines that a tagged term is located within the text of the response, the question follow-up module provides a follow-up question prompting the consumer to provide additional information with respect to the tagged term.

17. The system of claim 16, wherein, the follow-up question prompting the consumer to provide additional information with respect to the tagged term comprises a located attribute or entity and the tagged term.

18. A method for conducting real-time dynamic consumer surveys, the method under control of one or more computer systems, comprising:
providing a set of user-defined entities of interest related to a good or service stored in a data storage;
providing a set of user-defined attributes of interest related to a good or service stored in a data storage;
providing a processor coupled to the data storage;
a memory device including instructions that, when executed by the processor, causes the processor to execute instructions for:
(a) beginning a consumer survey by asking the consumer to provide an overall rating of experience with the good or service and providing an open-ended prompt to the consumer of the specific good or service regarding the consumers experience with said good or service;
(b) receiving the consumer's response to said open-ended prompt;
(c) analyzing the text of said response to the open-ended prompt to identify the presence of the user-defined entity or user-defined attribute; and
(d) determining whether the user-defined entity present in the text corresponds to the user-defined attribute.

19. The method of claim 18, wherein the step of determining whether the user-defined entity present in the text corresponds to the user-defined attribute comprises evaluating the linguistic connectivity between the user-defined entity and the user-defined attribute.

20. The method of claim 19, wherein the step of evaluating the linguistic connectivity of the user-defined entity and the user-defined attribute comprises a determination of a verb-phrase within the text of the response.

21. The method of claim 19, further comprising the step of determining the subject, object, and verb of the consumer response.
